(19) United States
(12) Patent Application Publication
(10) Pub. No.: US 2022/0153056 A1
(43) Pub. Date: May 19, 2022

(54) PRESENTATION DEVICE

(71) Applicant: Yen Chuin LIM, Blakehurst, NSW (AU)

(72) Inventor: Yen Chuin LIM, Blakehurst, NSW (AU)

(21) Appl. No.: 17/433,495

(22) PCT Filed: Feb. 25, 2020
(86) PCT No.: PCT/AU2020/050163

§ 371 Date: Aug. 24, 2021

(30) Foreign Application Priority Data
Feb. 25, 2019 (AU) 2019900588

(51) Int. Cl. B42F 7/06; G09B 21/00; A47G 1/06; G09F 7/22

(52) U.S. Cl. CPC B42F 7/065; G09F 7/22; A47G 1/065; G09B 21/00

(57) ABSTRACT

The present invention is broadly directed to a presentation device 10 in the form of an augmentative alternative communication AAC folio. The AAC folio 10 generally comprises:
1. three demountable leaf assemblies 12.1, 12.2, and 12.3 each adapted to contain a removable sheet including visual signs for communication;
2. coupling means in the form of a hinge shaft 14 arranged to engage the plurality of leaf assemblies 12.1 to 12.3 for interconnection to provide the AAC folio 10.

### TECHNICAL FIELD

The present invention is broadly directed to a presentation device and relates particularly, although not exclusively, to a presentation device in the form of an augmentative alternative communication (AAC) folio. The invention is also generally directed to a demountable leaf assembly for a presentation device.

### BACKGROUND

Aided AAC systems are known in supplementing or replacing speech or writing typically for those with speech or language impairments. The AAC system generally involves some form of tool or device. In its simplest form, the AAC tool may consist of pen and paper or alternatively pen/chalk and a board such as that used in an educational environment. In a more sophisticated form, the AAC device may include a computer screen on a mobile or desktop device where touching of the screen provides relevant audio. In both cases, the paper/board or screen includes different signs or indicia such as letters, words and/or pictures which allow the user of the AAC tool or device to effectively communicate by gesturing at or touching the signs/indicia.

The basic AAC tool in the form of pen and paper is temporary or single use in nature and relies upon equipment which may not be readily available. Furthermore, the equipment such as a pen or pencil may also cause injury to the user or educator if used inappropriately. To some extent, the computer-based AAC device addresses these shortcomings. Having said that, the computer-based device is relatively expensive and generally is not of sufficiently robust construction to tolerate rough handling it may be exposed to.

### SUMMARY OF INVENTION

According to a first aspect of the invention there is provided a demountable leaf assembly comprising:
a first layer including a first perimeter frame;
a second layer including a second perimeter frame releasably secured to the first perimeter frame in a sealed arrangement;
a leaf assembly seal located between the first and the second perimeter frames, said first and second layers together being adapted to contain a removable sheet.

According to a second aspect of the present invention there is provided a presentation device comprising:
a plurality of demountable leaf assemblies each adapted to contain a removable sheet, each of said leaf assemblies including:
a) a first perimeter frame;
b) a second perimeter frame releasably secured to the first perimeter frame in a sealed arrangement;
c) a leaf assembly seal located between the first and the second perimeter frames;
   coupling means arranged to engage the plurality of leaf assemblies for interconnection to provide the presentation device.

Preferably the demountable leaf assemblies each include hinge elements arranged to cooperate with one another via the coupling means wherein the presentation device is in the form of a book. More preferably the coupling means includes a hinge shaft extending through the hinge elements to form a hinged connection along a common boundary of the book.

Alternatively the coupling means comprises a framework assembly including a plurality of leaf frames each having hinge elements arranged to cooperate with one another wherein the presentation device is in the form of a book. In this embodiment the coupling means also comprises a hinge shaft extending through the hinge elements to form a hinged connection along a common boundary of the book. In this example the plurality of demountable leaf assemblies are configured to cooperate with respective of the plurality of leaf frames for detachable mounting within said frames. In this alternative embodiment respective of the leaf assemblies are press or snap fitted within the leaf frames.

Preferably each of the demountable leaf assemblies includes an outer or the first layer detachably connected to an inner or the second layer in a sandwich arrangement wherein the removable sheet is sandwiched between the outer and the inner layers. More preferably each of the outer or the first layer and the inner or second layers includes a substantially transparent or semi-transparent panel through which the visual signs of the contained removable sheet can be viewed.

Preferably each of the outer and the inner layers includes respective of outer and inner perimeter frames configured to be releasably secured to one another in a sealed arrangement. More preferably the plurality of demountable leaf assemblies each include a plurality of fasteners designed to engage both the outer and the inner frames to effect securement of the outer and the inner layers to one another in the sealed arrangement. Alternatively the outer and the inner perimeter frames are configured for press or snap fitting with one another to effect securement of the outer and the inner layers to one another in the sealed arrangement.

Preferably each of the leaf assemblies includes a leaf assembly seal located between the outer and the inner frames. Alternatively the outer and the inner layers include respective of outer and inner seals arranged to cooperate with one another for sealing of the demountable leaf assembly on securement of the outer and inner perimeter frames to one another for sealing of the demountable leaf assembly.

Preferably an outermost pair of the demountable leaf assemblies are of substantially identical construction. More preferably hinge elements of the outermost pair of leaf assemblies are in the hinge connection axially offset relative to one another along the hinge shaft.

Preferably one of the outer layer or the inner layer is formed in one piece. More preferably the transparent or semi-transparent panel of said one of the outer or inner layers is formed integral with the corresponding outer or inner frames. Even more preferably the other of the outer or inner layers includes the transparent or semi-transparent panel separate from the corresponding outer or inner frames. Still more preferably said other of the outer or inner layers seals with said corresponding frame. Alternatively the transparent or semi-transparent panel of both the outer and inner layers is formed integral with the corresponding outer and inner frames.

Preferably the presentation device is in the form of an augmentative alternative communication (AAC) folio.

### BRIEF DESCRIPTION OF DRAWINGS

In order to achieve a better understanding of the nature of the present invention a preferred embodiment of a presentation device will now be described, by way of example only, with reference to the accompanying drawings in which:

FIG. 1 is a perspective view of a presentation device according to an embodiment of a first aspect of the present invention shown in its closed book configuration;

FIG. 2 is a perspective view of the presentation device of the embodiment of FIG. 1 with one of the leaf assemblies shown opened relative to the other two leaf assemblies which remain closed;

FIG. 3 is a perspective view of the presentation device of the embodiment of FIGS. 1 and 2 with each of the leaf assemblies partly open relative to one another wherein the book is in an open configuration;

FIG. 4 is a partly exploded perspective view of the presentation device of the embodiment of the preceding figures;

FIG. 5 is an exploded perspective view of an outermost of one of the leaf assemblies taken from the presentation device of the embodiment of the preceding figures;

FIG. 6 is an inner plan view of the leaf assembly of the embodiment of FIG. 5 in its assembled condition;

FIGS. 7A and 7B are sectional and detail views taken at A-A of the leaf assembly of the embodiment of FIG. 6;

FIG. 8 is a sectional view taken at A-A of the leaf assembly of the embodiment of FIG. 6 in its disassembled condition;

FIG. 9 is a perspective view of a demountable leaf assembly according to an embodiment of another aspect of the invention shown in its assembled condition;

FIG. 10 is a perspective view of the demountable leaf assembly of the embodiment of FIG. 9 in its disassembled condition;

FIGS. 11A and 11B are sectional and detail views of the leaf assembly of the embodiment of FIG. 9;

FIGS. 12A and 12B are sectional and detail views shown exploded of the leaf assembly of the embodiment of FIG. 9;

FIGS. 13A and 13B are perspective views of a presentation device according to another embodiment of the first aspect of the invention shown in its closed book and partly open configurations;

FIG. 14 is an exploded perspective view of the presentation device of the other embodiment of FIG. 13;

FIG. 15 is an exploded perspective view of part of the presentation device of the other embodiment of FIGS. 13 and 14;

FIGS. 16A to 16C are plan, sectional and detail views of the presentation device of the other embodiment of FIGS. 13 to 15;

FIGS. 17A and 17B are plan views of the presentation device of the other embodiment showing an associated strap detached and attached, respectively;

FIG. 18 is a perspective view of a presentation device according to a further embodiment of the first aspect of the invention in its open configuration;

FIG. 19 is a perspective view of the presentation device of the further embodiment of FIG. 18 showing an associated portable device partly removed.

### DETAILED DESCRIPTION

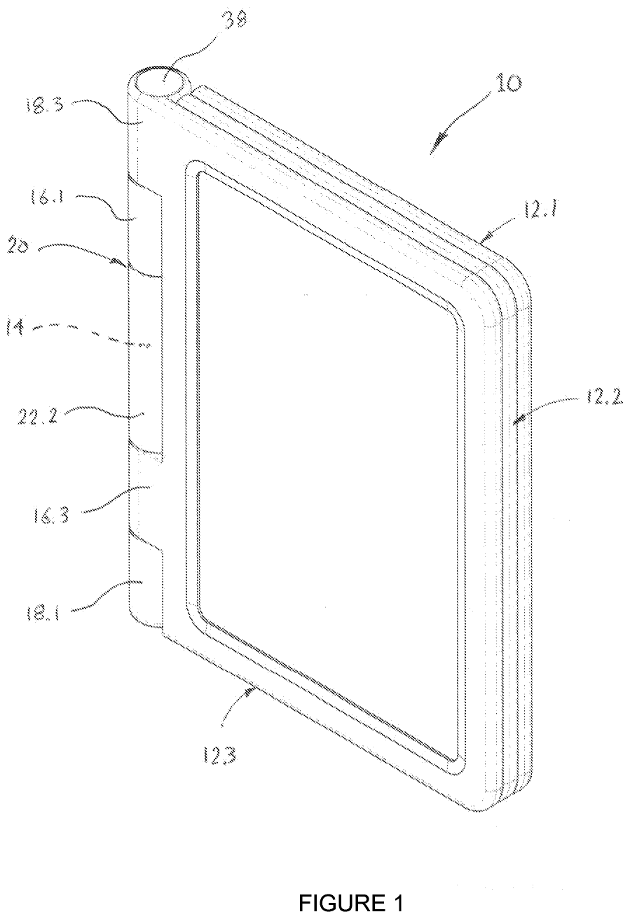

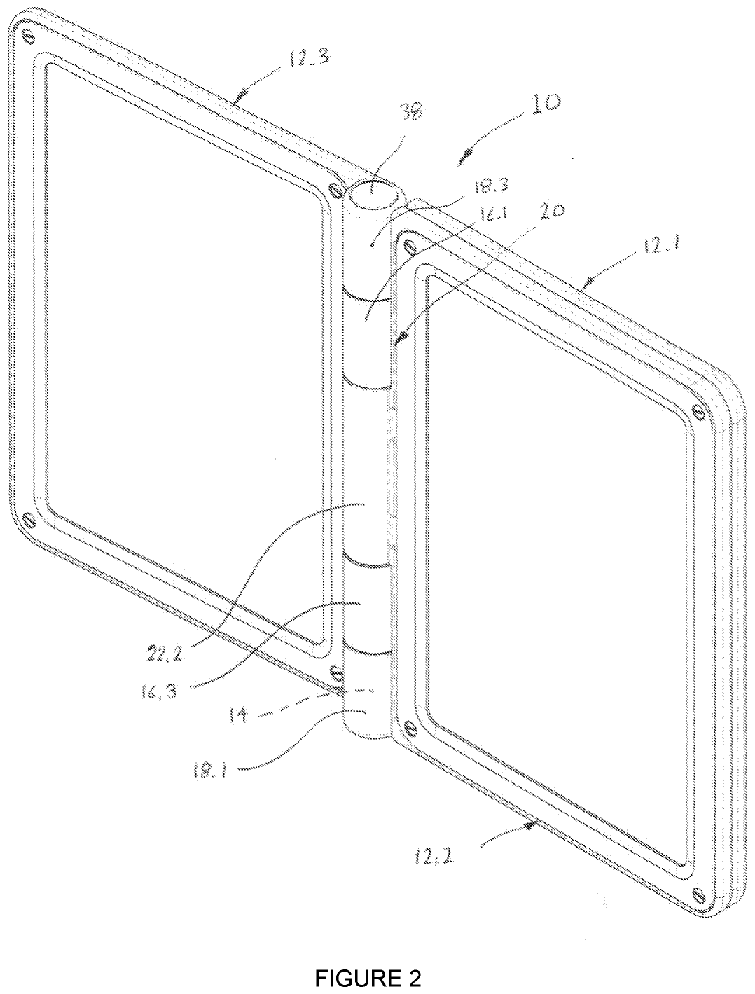

As seen in FIGS. 1 to 4, there is a presentation device 10 of an embodiment of a first aspect of the invention in the form of an augmentative alternative communication (AAC) folio. The AAC folio 10 of this embodiment generally comprises:
1. three (3) demountable leaf assemblies 12.1, 12.2 and 12.3 each adapted to contain a removable sheet (not shown) including visual signs for communication;
2. coupling means in the form of a hinge shaft 14 arranged to engage the plurality of leaf assemblies 12.1 to 12.3 for interconnection to provide the AAC folio 10.

In this embodiment the demountable leaf assemblies such as 12.1 each include hinge elements 16.1 and 18.1 arranged to cooperate with one another via the hinge shaft 14. The hinge shaft 14 extends through the hinge elements such as 16.1 and 18.1 to form a hinged connection 20 along a common boundary or side of the leaf assemblies 12.1 to 12.3. The AAC folio 10 is thus in the form of a book wherein the hinge connection 20 resembles a piano hinge.

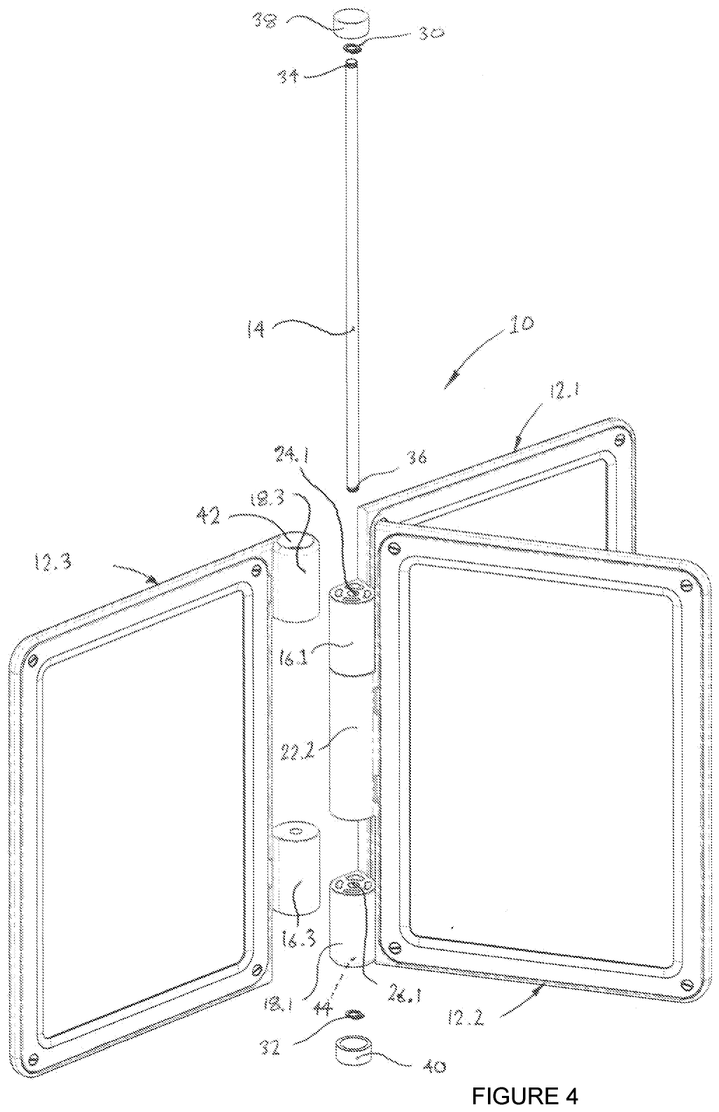

As best seen in FIG. 4, the hinge shaft 14 of this example extends through the pair of hinge elements 16.1 and 18.1 of the outer leaf assembly 12.1, the intermediate hinge element 22.2 of the intermediate leaf assembly 12.2, and the pair of hinge elements 16.3 and 18.3 of the other outer leaf assembly 12.3. Each of the two pairs of hinge elements 16.1 and 18.1 associated with the leaf assembly such as 12.1 are of a substantially identical construction. The hinge elements 16.1 and 18.1 each include a hinge knuckle having respective elongate bores 24.1 and 26.1 through which the hinge shaft 14 passes. The hinge element 22.2 of the intermediate leaf assembly 12.2 includes the single hinge knuckle having an elongate bore (not shown) for receipt of the hinge shaft 14.

In this embodiment the outermost pair of demountable leaf assemblies 12.1 and 12.3 are of substantially identical construction. In order to achieve this modularity in the outermost leaf assemblies 12.1 and 12.3, the hinge elements or in this case hinge knuckles such as 16.1 and 18.3 as well as 18.1 and 16.3 in the piano-type hinge connection 20 are axially offset relative to one another along the hinge shaft 14. In this example of the AAC folio 10, the intermediate leaf assembly 12.2 includes the single hinge knuckle 22.2 which is longer than the hinge knuckles such as 16.1 and 18.1 associated with the outer leaf assemblies such as 12.1 and occupies the remaining space between adjacent of the hinge knuckles 16.1 and 16.3.

It will be understood that in another embodiment the intermediate leaf assembly 12.2 may be replaced with a pair of inner leaf assemblies of substantially identical construction each having a pair of hinge elements axially offset relative to one another and thus configured in a similar manner to the hinge elements such as 16.1 and 18.1 of the outer leaf assemblies such as 12.1. In both of these embodiments the hinge shaft 14 is retained in engagement with the leaf assemblies 12.1 to 12.3. This retention is effected by a pair of circlips 30 and 32 configured to engage respective of a pair of grooves 34 and 36 at each end of the hinge shaft 14. The AAC folio 10 of this embodiment includes a pair of end plugs 38 and 40 press fit within end cavities 42 and 44 of respective of the hinge knuckles 18.1 and 18.3.

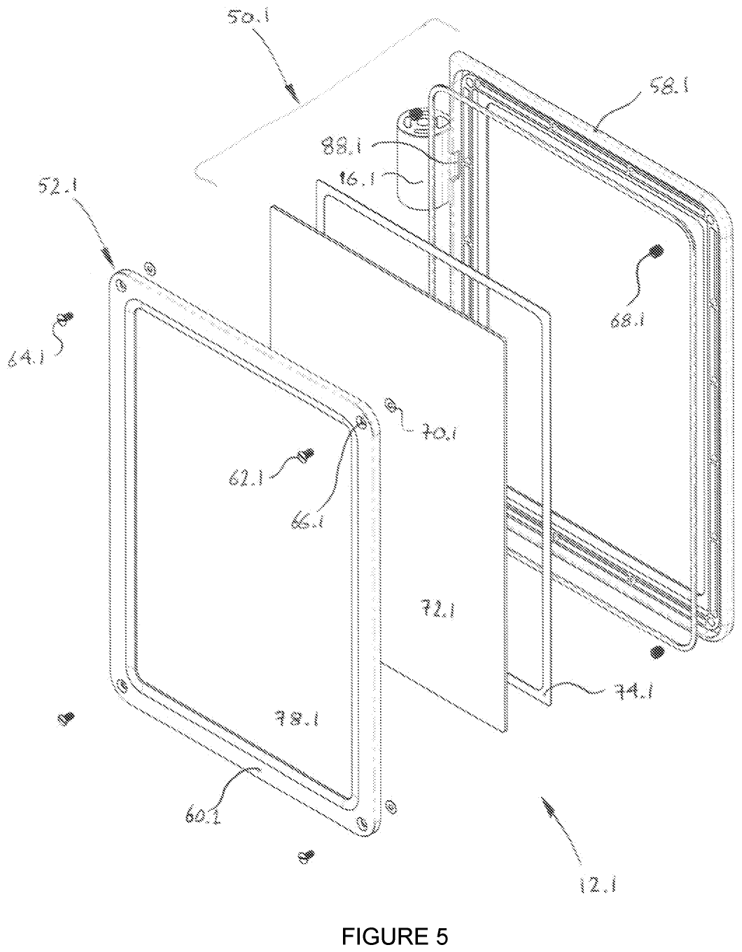

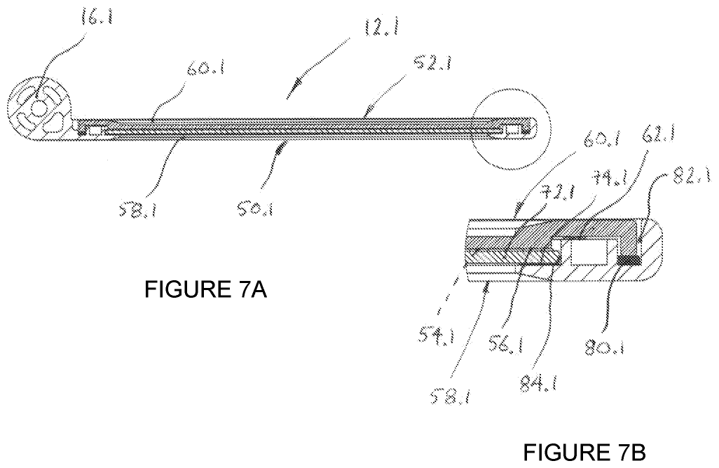

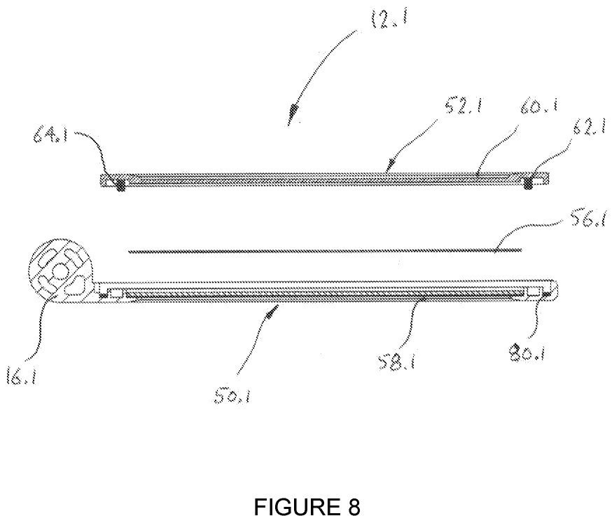

FIG. 5 best illustrates in exploded view one of the outer leaf assemblies 12.1 taken from the AAC folio 10 of the preceding embodiment. In this example, with the exception of the intermediate leaf assembly 12.2, it is to be understood that all of the leaf assemblies 12.1 to 12.3 are of substantially identical construction. The demountable leaf assembly 12.1 generally includes an outer layer 50 connected to an inner layer 52.1 in a sandwich arrangement. As best seen in FIGS. 7 and 8, the outer and inner layers 50.1 and 52.1 define a chamber 54.1 therebetween. The removable sheet such as 56.1 is contained within the chamber 54.1 for each of the demountable leaf assemblies such as 12.1.

Returning to FIG. 5, each of the outer and the inner layers 50.1 and 52.1 includes respective of outer and inner perimeter frames 58.1 and 60.1. In this example the perimeter frames 58.1 and 60.1 are configured to be releasably secured to one another in a sealed arrangement via a plurality of fasteners such as 62.1 and 64.1. Each of the fasteners such as 62.1 passes through an aperture 66.1 in the inner perimeter frame 60.1 and threadably engages a threaded insert 68.1 retained in the outer perimeter frame 58.1. The screw fastener such as 62.1 on release from the threaded insert 68.1 remains secured to the inner perimeter frame 60.1 via a retaining washer 70.1 which is frictionally fit to the threaded fastener 62.1. This arrangement also assists with release of the inner perimeter frame 60.1 from the outer perimeter frame 58.1 on unscrewing and removal of the fasteners such as 62.1.

In this embodiment the outer layer 50.1 includes a transparent or semi-transparent panel 72.1 separate from the perimeter frame 58.1. The separate panel 72.1 mounts within the perimeter frame 58.1 via a gasket 74.1 which seals the junction between the perimeter frame 58.1 and the separate transparent or semi-transparent panel 72.1. The inner layer 52.1 of this outer leaf assembly 12.1 is formed in one piece wherein a transparent or semi-transparent panel 78.1 is formed integral with the corresponding inner perimeter frame 60.1. It will be appreciated that the visual signs of the removable sheet such as 56 can be viewed through either the separate transparent panel 72.1 or the integral transparent panel 78.1.

As best seen in FIGS. 7 and 8 the demountable leaf assemblies such as 12.1 each include a leaf assembly seal 80.1 located between the outer and the inner frames 58.1 and 60.1. In this example the seal 80.1 is continuous and seats within a corresponding channel 82.1 formed on an inside face of the outer perimeter frame 58.1. The gasket 74.1 is also continuous and seats within a corresponding rebate 84.1 also formed on an inside face of the outer perimeter frame 58.1. It will be understood that the removable sheet such as 56.1 is loosely positioned between the outer and the inner layers 50.1 and 52.1 of the demountable leaf assembly 12.1 in its disassembled condition as seen in FIG. 8. The removable sheet 56.1 is thereafter clamped and thus contained between the outer and the inner layers 50.1 and 52.1 in their assembled condition as seen in FIG. 7.

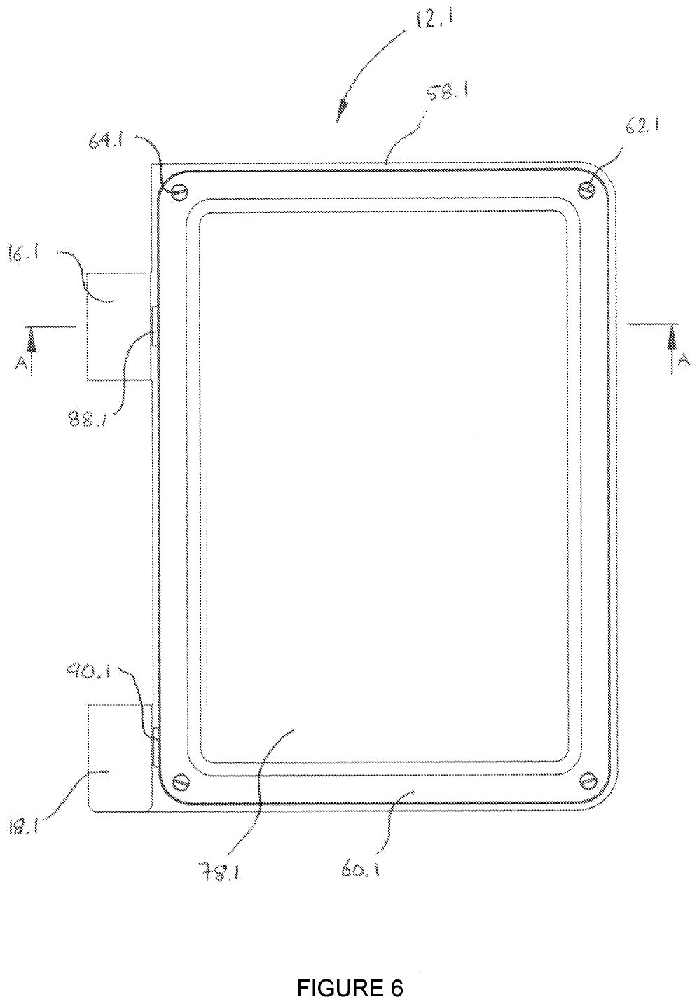

In this example and as seen in FIGS. 5 to 8, the outer perimeter frame such as 58.1 includes a pair of slots 88.1 and 90.1 conveniently located adjacent respective of the hinge elements such as 16.1. The slots such as 88.1 serve two (2) functions, namely:
1. they provide access for a finger or other implement which is inserted into the slot such as 88.1 to facilitate release of the inner layer 52.1 from the outer layer 50.1;
2. in moulding of the outer perimeter frame 58.1, the slot such as 88.1 reduces the mass of material around the hinge element such as 16.1 reducing sinking in this region of the frame 58.1.

Although not illustrated, the AAC folio 10 may include magnets or other retention means designed to retain the AAC folio 10 in its closed book configuration. Alternatively or additionally, the coupling means for the hinged connection of the preferred embodiment may include resistance means designed to retain the AAC folio 10 in its closed or incremental open book configurations.

In this embodiment and as best seen in the detail view of FIG. 7, boundary or perimeter edges of the demountable leaf assembly such 12.1 are radiused for each ease of manipulation by the user in separating the leaf assemblies 12.1 to 12.3 of the AAC folio 10. The perimeter edges of the outer perimeter frame 58.1 are appropriately radiused in order to provide this “purchase” for opening. Alternatively or additionally, one or more of the leaf assemblies 12.1 to 12.3 may include a tab (not illustrated) which extends from the outer or inner perimeter frames 58.1 and 60.1 to assist with separate of the leaf assemblies 12.1 to 12.3 on opening of the AAC folio 10.

It is to be understood that the AAC folio 10 of this embodiment is designed to contain a removable sheet such as 56.1 of practically any material or size/configuration. The removable sheet 56.1 is typically made of paper to which visual signs are applied on one or both faces. The visual signs for the purpose of AAC are intended to provide visual aids and prompts to assist a user with communicating their daily needs. The visual signs may be selected from a library of signs including images and/or other communication content. In tailoring the AAC folio to the needs and requirements of a particular user, specific signs may be selected from the library and printed to the removable sheet for inclusion in the AAC folio. The library of visual signs may conveniently be located within a website to be found on the internet or alternatively in an App designed for this purpose. It will be understood that parents or carers may access the website or App in order select and print images to the removable sheet(s) for inclusion in the AAC folio. Alternatively, the parents or carers may hand sketch or otherwise illustrate the required visual signs on the removable sheet.

It is most likely that the AAC folio 10 or other presentation device of the present invention will be designed to accommodate removable sheets in the form of paper of standard sizes. For example, a smaller version of the AAC folio may be designed to handle paper of an A4 or equivalent size. Generally, visual signs will be applied to one face of the A4 paper which is then folded in half to effectively provide paper of an A5 or equivalent size. The relatively small AAC folio 10 is in this case designed to accommodate paper of the A5 or equivalent size where the visual signs can be viewed through opposing transparent or semi-transparent panels of the demountable leaf assembly. In a larger version of the AAC folio, the visual signs are applied to one face of an A3 or equivalent sheet of paper which is folded in half. The relatively large AAC folio is in this case sized to accommodate the resulting A4 or equivalent sized sheet. It will be appreciated that the A4 sized AAC folio will also accommodate a single A4 sheet or equivalent with visual signs applied to one or both sides. The demountable leaf assemblies may also contain more than one sheet of paper, for example the A4 sized AAC folio may include two sheets of A4 size paper arranged back to back.

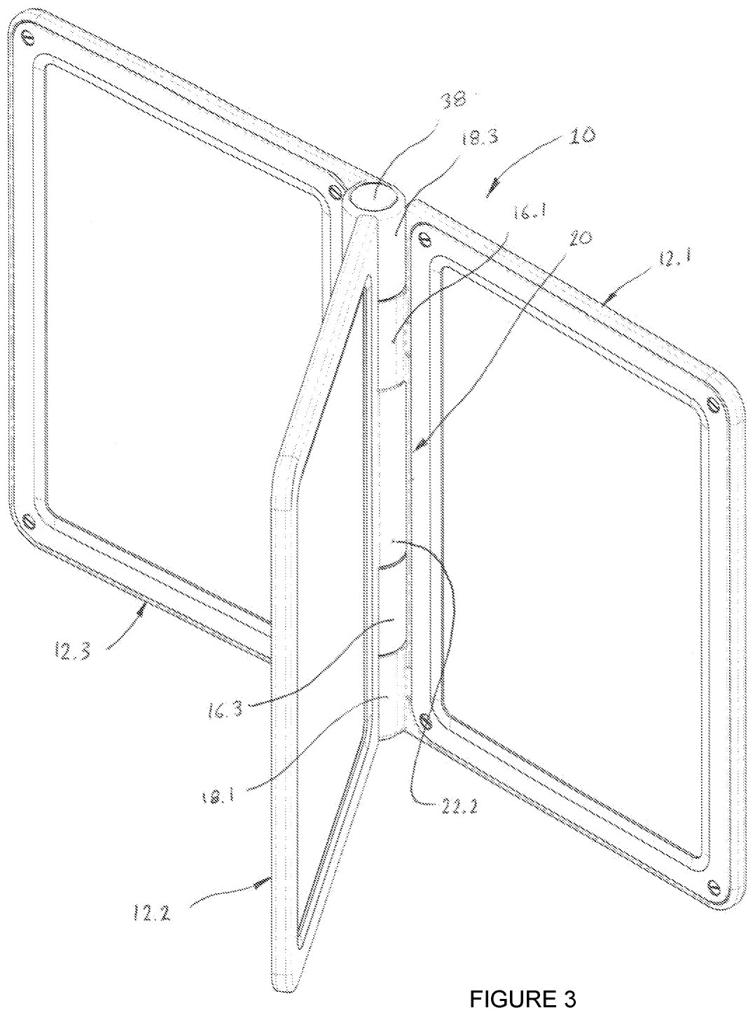

It will be understood that the AAC folio 10 may be held in a conventional manner and used in the form of a book. The AAC folio 10 of this embodiment is also designed to function as a display device where one or both of the outer leaf assemblies 12.1 and 12.3 provides a base for resting of the AAC folio 10 on an appropriate surface, such as a table. This mode of operation is best seen in FIG. 3 where the intermediate leaf assembly 12.2 provides the requisite “display” for the AAC folio 10 where conveniently the intermediate leaf assembly 12.2 can be pivoted to the desired angle for viewing. It will be appreciated that in a simpler form the AAC folio 10 includes the pair of outer leaf assemblies 12.1 and 12.3 only where in the “display” mode one of the leaf assemblies such as 12.1 provides support for the folio 10 whilst the other leaf assembly such as 12.3 displays the visual signs.

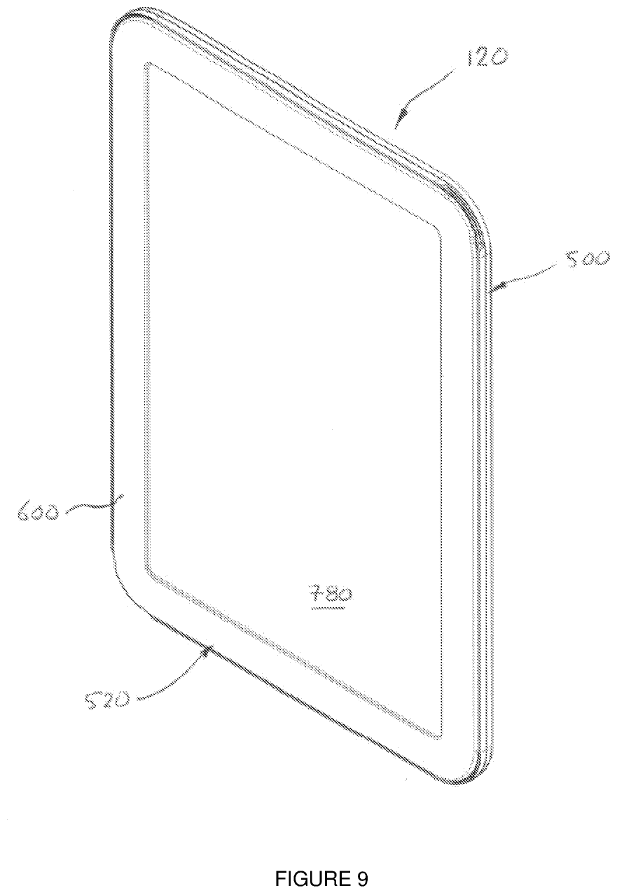

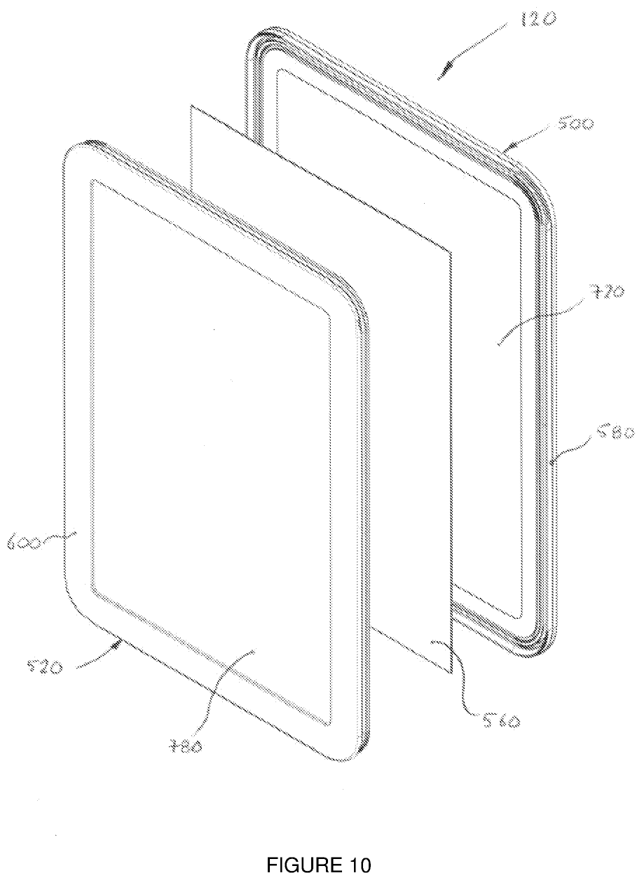

As seen in FIGS. 9 to 12, there is a demountable leaf assembly 120 of an embodiment of a second aspect of the invention. The leaf assembly 120 generally comprises a first layer 500 detachably connected to a second layer 520, said layers 500 and 520 together being adapted to contain a removable sheet 560.

The first layer 500 is in this embodiment formed in one piece including a perimeter frame 580 formed integral with a transparent panel 720. The second panel 520 is of similar construction to the first panel 500 wherein it includes a perimeter frame 600 formed integral with a transparent panel 780. In this example the first and the second perimeter frames 580 and 600 are configured for press or snap fitting with one another to effect securement of the first and second layers 500 and 520 to one another in a sandwich arrangement. The removable sheet 560 is sandwiched between the first and the second layers 500 and 520 and visual signs for communication included on the removable sheet 560 can be viewed through either of the transparent panels 720 or 780.

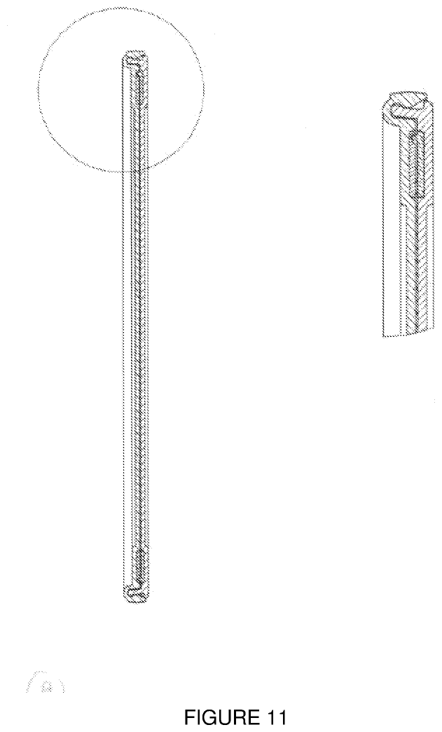

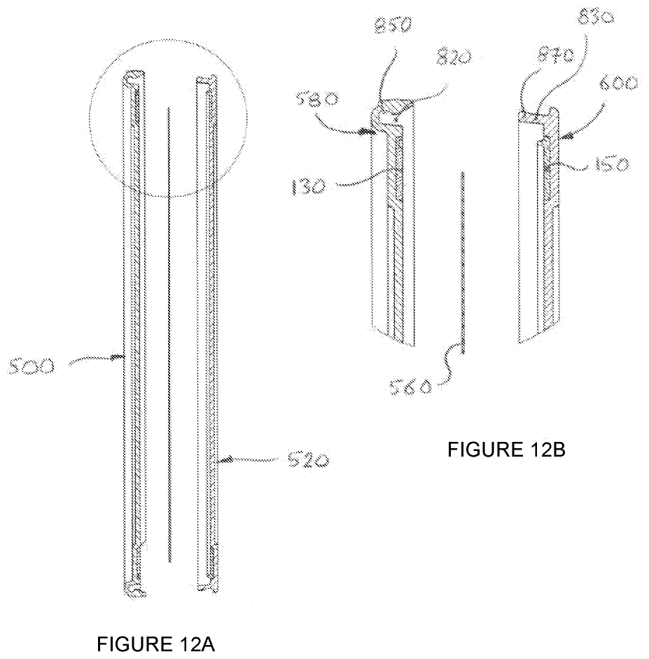

As best seen in FIGS. 11 and 12, the first and second layers 500 and 520 include respective of first and second seals 130 and 150 arranged to cooperate with one another for sealing of the demountable leaf assembly 120 on securement of the first and second perimeter frames 580 and 600 to one another. In this example the first and second seals 130 and 150 are in the form of compression gaskets overmoulded internally of the respective first and second perimeter frames 580 and 600. The first seal 130 is configured as a female seal whereas the second seal 150 is configured as a male seal together arranged on press or snap fitting of the first and second perimeter frames 580 and 600 to provide effective sealing of the demountable leaf assembly 120.

As further seen in FIGS. 11 and 12, the first and second perimeter frames 580 and 600 include a perimeter channel 820 and a corresponding perimeter flange 830 for mating with one another on press or snap fitting of the first and second layers 500 and 520. In this example the perimeter channel 820 includes an undercut 850 configured for releasable engagement with a corresponding rib 870 of the perimeter flange 830. The perimeter flange 830 thus releasably engages the perimeter channel 820 on press or snap fitting of the first and second perimeter frames 580 and 600 with one another wherein:
1. the first and second layers 500 and 520 can be ejected from one another by releasing the perimeter rib 870 from the corresponding undercut 850;
2. the interengaged perimeter flange 830 and corresponding perimeter channel 820 are configured to provide a secondary seal supplementing the first and second seals 130 and 150 in preventing the ingress of liquid or particulates to the removable sheet 560.

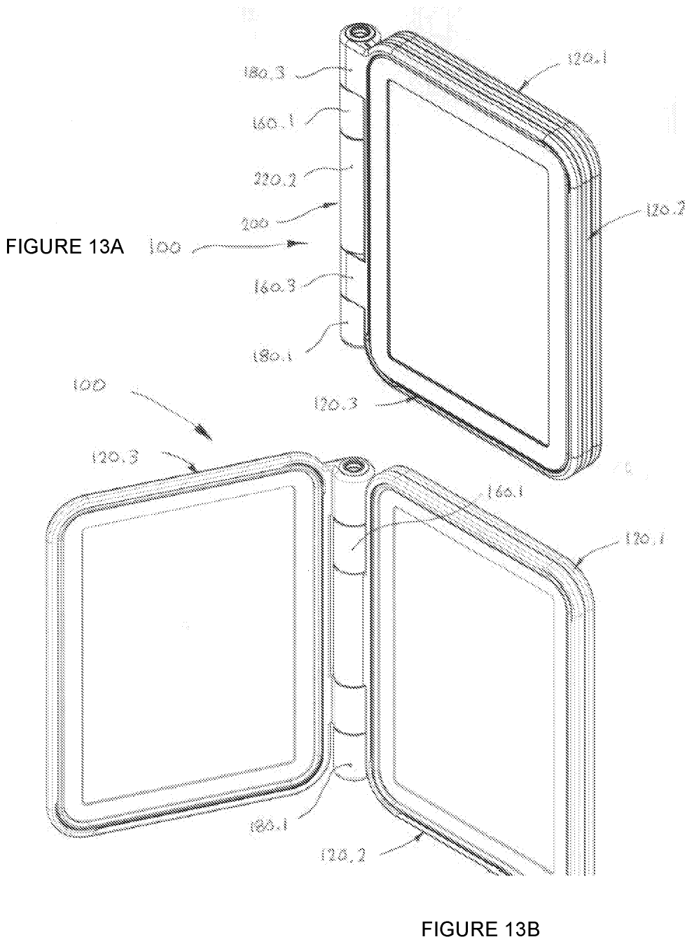

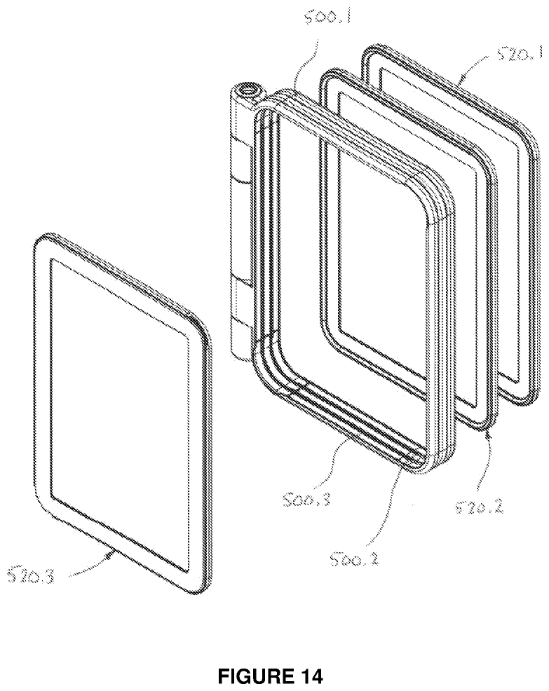

FIGS. 13 to 17 depict a presentation device 100 of another embodiment of the first aspect of the invention in the form of an AAC folio 100. The AAC folio 100 of this other embodiment is similar to the AAC folio 10 of the earlier embodiment except the demountable leaf assemblies such as 120.1 are or substantially identical construction to the leaf assembly 120 described in the preceding paragraphs and illustrated in FIGS. 9 to 12. In this other embodiment the coupling means comprises a framework assembly 170 including three (3) leaf frames 190.1, 190.2, and 190.3 each having hinge elements such as 210.1 and 230.1 arranged to cooperate with one another. The coupling means also comprises a hinge shaft 140 extending through the hinge elements such as 210.1 and 230.1 to form a hinged connection 200 wherein the presentation device is in the form of a book.

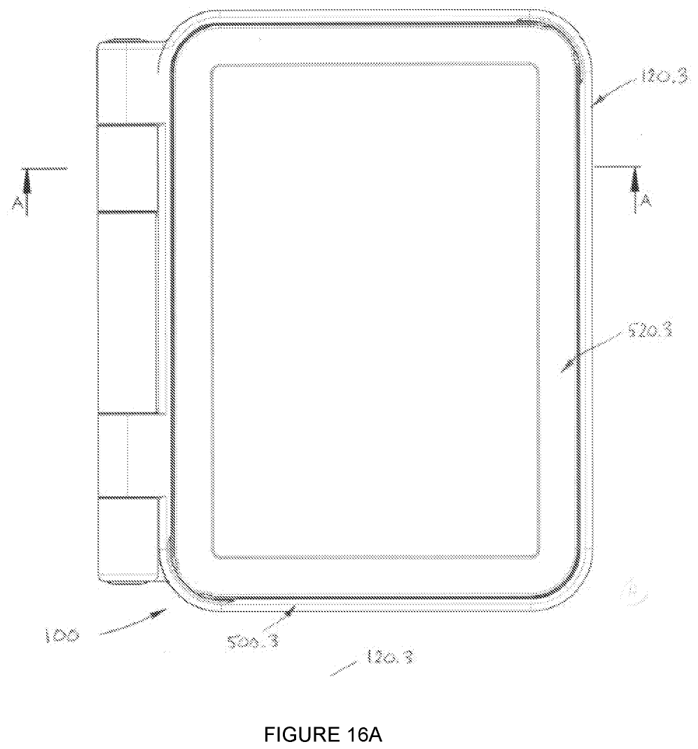

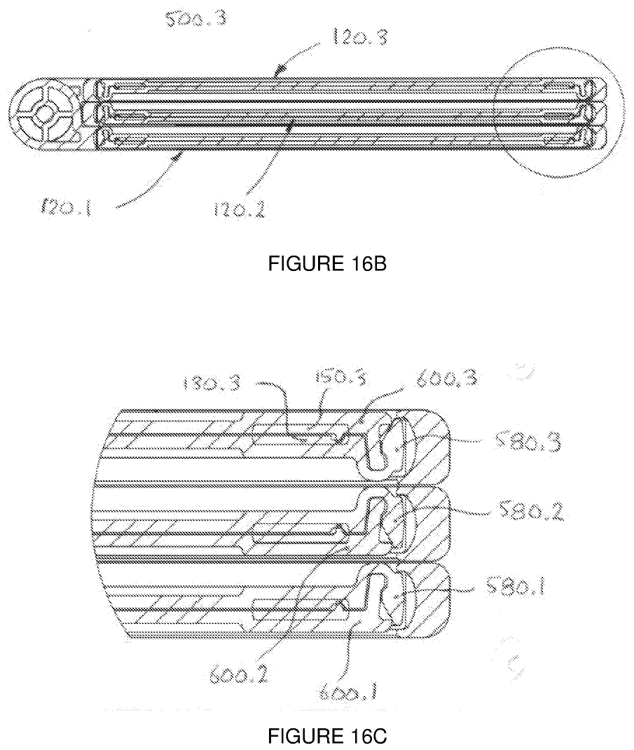

As best seen in FIGS. 16A to 16C the demountable leaf assemblies 120.1 to 120.3 are of identical construction and configured to cooperate with respective of the plurality of leaf frames 190.1 to 190.3 for detachable mounting within said frames. In this example the leaf frames such as 190.1 include an internal groove 250.1 configured for press or snap fitting of the corresponding demountable leaf assembly 120.1 within the leaf frame 190.1. It will be noted that the perimeter frames such as 190.2 and 190.3 are designed to receive respective of the leaf assemblies such as 120.2 and 120.3 in either a face up or a face down disposition.

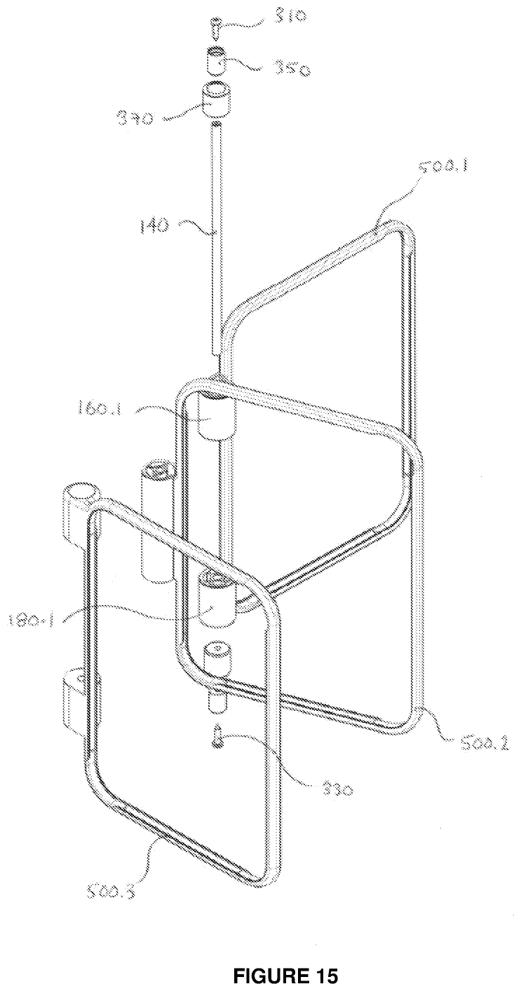

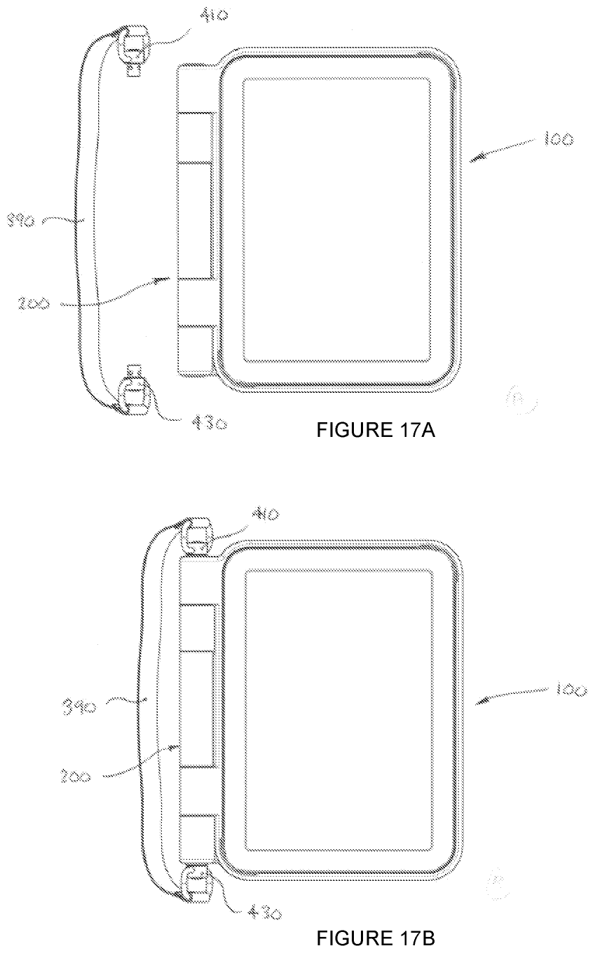

As seen in FIG. 15 or 17, the hinged connection 200 of this other embodiment represents a departure from the earlier embodiment where in this instance:
1. the circlips 30 and 32 of the earlier embodiment are replaced with screws 310 and 330 arranged to axially fasten a pair of bushes such as 350 and 370 to opposing ends of the hinge shaft 140 (see FIG. 15);
2. a detachable strap 390 having coupling elements 410 and 430 at each of its opposing ends is designed to releasably connect or plug into respective of one of the bushes such as 370 at opposing ends of the hinged connection 200 (see FIG. 17).

FIG. 16 illustrates the AAC folio 100 of this other embodiment in its closed book configuration. The sectional representations of FIGS. 16B and 16C show in detail the sandwich construction of each of the leaf assemblies such as 120.1 and more particularly their snap or press fitting and sealing arrangements. For clarity purposes the AAC folio 100 is in these illustrations shown without the removable sheet.

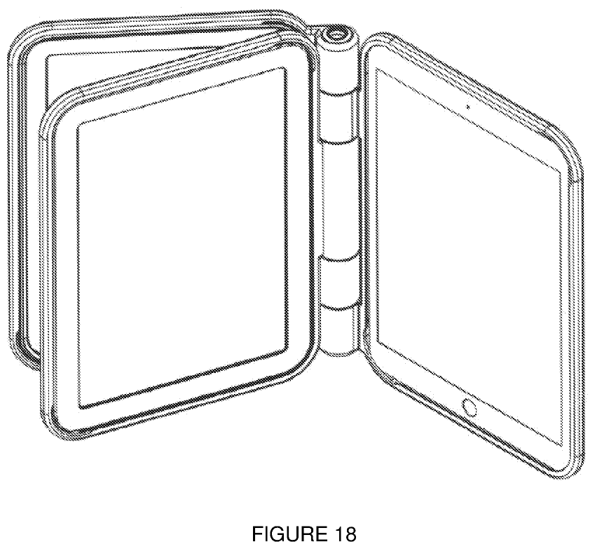

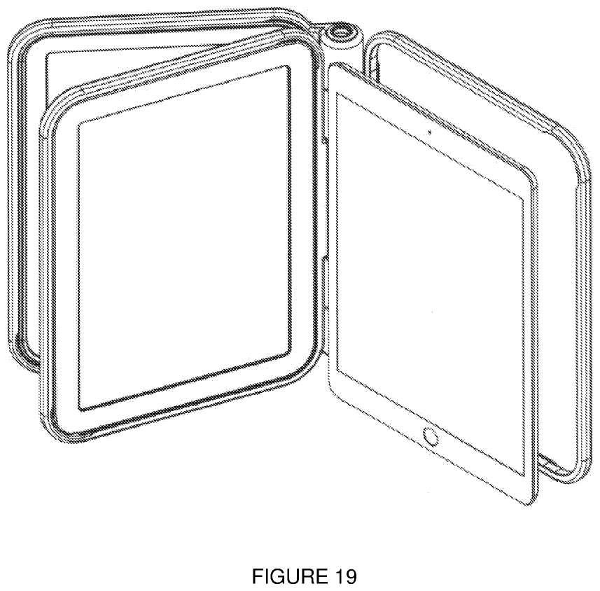

FIGS. 18 and 19 illustrate a variation from the AAC folio 100 or other presentation device of the preceding embodiment. In this variation the presentation device 1000 is similar to the preceding embodiment being of a three-leaf configuration wherein:
1. the second and third leaf assemblies 1200.2 and 1200.3 and their corresponding leaf frames 1900.2 and 1900.3 are identical to the preceding embodiment;
2. the first leaf frame 1900.1 is designed specifically for releasable mounting of a mobile device such as an iPad (registered trade mark of Apple Inc).

In this variation the internal groove 2500.1 of the first leaf frame 1900.1 is designed to receive the perimeter of the iPad or other mobile device 2900 in a press or snap fitting arrangement.

Now that a preferred embodiment of the invention has been described it will be understood that the presentation device and demountable leaf assembly have at least the following advantages:
1. the presentation device and leaf assembly can be constructed in a sufficiently robust design where the removable sheet(s) carrying the visual signs are unlikely to be damaged;
2. the presentation device and leaf assembly are designed in their preferred form for sealing containment of the removable sheet which is thus less susceptible to damage via liquid or other contaminants;
3. the presentation device and leaf assembly can be constructed of relatively lightweight materials, such as an acrylic or polycarbonate material, so that it can be handled with relative ease and should it become a projectile it is unlikely to cause significant damage;
4. the design of the demountable leaf assembly means removable sheets can be replaced or substituted with relative ease whilst at the same time ensuring that damage or inadvertent removal of the sheets does not occur;
5. the presentation device can be constructed in a modular form which is expected to reduce manufacturing costs.

Those skilled in the art will appreciate that the invention described herein is susceptible to variations and modifications other than those specifically described. For example, the demountable structure of the leaf assembly may vary provided it contains a removable sheet. The presentation device or demountable leaf assembly is not limited to AAC and extends to other multi-use applications including but not limited to stationery and signage. The coupling means may depart from the hinged arrangement of the preferred embodiment where for example the hinge is replaced with a flexible coupling which in a similar manner to the spine of a book interconnects the leaf assemblies and permits their separation for viewing of the visual signs.

All such variations and modifications are to be considered within the scope of the present invention the nature of which is to be determined from the foregoing description.

1-23. (canceled)

24. A demountable leaf assembly comprising:
a first layer including a first perimeter frame;
a second layer including a second perimeter frame releasably secured to the first perimeter frame in a sealed arrangement;
a leaf assembly seal located between the first and the second perimeter frames, said first and second layers together being adapted to contain a removable sheet.

25. A demountable leaf assembly as claimed in claim 24 wherein the first layer is detachably connected to the second layer in a sandwich arrangement wherein the removable sheet is sandwiched between said layers.

26. A demountable leaf assembly as claimed in claim 25 wherein the first layer and the second layer each include a substantially transparent or semi-transparent panel through which the contained removable sheet can be viewed.

27. A demountable leaf assembly as claimed in claim 24 also comprising a plurality of fasteners configured to engage both the first and the second frames to effect securement of the first and the second layers to one another in the sealed arrangement.

28. A demountable leaf assembly as claimed in claim 24 wherein the first and the second perimeter frames are configured for press or snap fitting with one another to effect securement of the first and the second layers to one another in the sealed arrangement.

29. A demountable leaf assembly as claimed in claim 24 wherein the first and the second layers include respective first and second seals arranged to cooperate with one another to seal the demountable leaf assembly on securement of the first and second perimeter frames to one another to seal the demountable leaf assembly.

30. A demountable leaf assembly as claimed in claim 26 wherein one of the first layer or the second layer is formed in one piece.

31. A demountable leaf assembly as claimed in claim 30 wherein the transparent or semi-transparent panel of said one of the first or second layers is formed integral with the corresponding first or second perimeter frames.

32. A demountable leaf assembly as claimed in claim 31 wherein the other of the first or second layers includes the transparent or semi-transparent panel separate from the corresponding first or second perimeter frames.

33. A demountable leaf assembly as claimed in claim 32 wherein the other of the first or second layers seals with the corresponding perimeter frame.

34. A demountable leaf assembly as claimed in claim 26 wherein the transparent or semi-transparent panel of both the first and second layers is formed integral with the corresponding first and second perimeter frames.

35. A presentation device comprising:
a plurality of demountable leaf assemblies as claimed in claim 24;
coupling means arranged to engage the plurality of leaf assemblies for interconnection to provide the presentation device.

36. A presentation device comprising:
a plurality of demountable leaf assemblies each adapted to contain a removable sheet, each of the leaf assemblies including:
a) a first perimeter frame;
b) a second perimeter frame releasably secured to the first perimeter frame in a sealed arrangement; and
c) a leaf assembly seal located between the first and the second perimeter frames; and
coupling means arranged to engage the plurality of leaf assemblies for interconnection to provide the presentation device.

37. A presentation device as claimed in claim 36 wherein the demountable leaf assemblies each include hinge elements arranged to cooperate with one another via the coupling means wherein the presentation device is in the form of a book.

38. A presentation device as claimed in claim 37 wherein the coupling means includes a hinge shaft extending through the hinge elements to form a hinged connection along a common boundary of the plurality of leaf assemblies.

39. A presentation device as claimed in claim 36 wherein the coupling means comprises a framework assembly including a plurality of leaf frames each having hinge elements arranged to cooperate with one another wherein the presentation device is in the form of a book.

40. A presentation device as claimed in claim 39 wherein the coupling means also comprises a hinge shaft extending through the hinge elements to form a hinged connection along a common boundary of the book.

41. A presentation device as claimed in claim 39 wherein the plurality of demountable leaf assemblies are configured to cooperate with respective of the plurality of leaf frames for detachable mounting within said frames.

42. A presentation device as claimed in claim 41 wherein respective of the leaf assemblies are press or snap fitted within the leaf frames.

43. A presentation device as claimed in claim 36 wherein the removable sheet includes visual signs for communication and the presentation device is in the form of an augmentative alternative communication folio.
